(19) United States
(12) Patent Application Publication
(10) Pub. No.: US 2011/0149798 A1
(43) Pub. Date: Jun. 23, 2011

(54) DEVICE, SYSTEM AND METHOD OF COMMUNICATING USING CONFIGURED TRANSMISSION DIRECTIONALITY

(76) Inventors: Carlos Cordeiro, Portland, OR (US); Solomon Trainin, Haifa (IL); Assaf Kasher, Haifa (IL); Michelle X. Gong, Sunnyvale, CA (US)

(21) Appl. No.: 12/645,515

(22) Filed: Dec. 23, 2009

(51) Int. Cl. H04L 12/28

(52) U.S. Cl. 370/254

(57) ABSTRACT

Some demonstrative embodiments include devices, systems and/or methods of communicating using configured antenna directionality. For example, a wireless communication unit of a wireless communication device may detect another wireless communication device based on one or more beacons, to configure a directional wireless transmission scheme for communicating with the other wireless communication device based on the one or more beacons, and to establish a wireless communication link with the other wireless communication device using the directional wireless transmission scheme. Other embodiments are described and claimed.

### BACKGROUND

The proliferation of mobile personal and handheld devices and significant improvements in their capabilities have led to rapid development of many new types of uses and connectivities, for example, peer-to-peer (P2P) networks. Contrary to traditional Wi-Fi or cellular applications where client stations (STA) connect to a dedicated access point (AP) or base station (BS), P2P networks are characterized by their “ad-hoc” nature where any STA can connect to other STA's without the need for a dedicated AP/BS. P2P networks have advanced a variety of new applications such as, for example, wireless display, sync&go, wireless computing (including wireless USB and PCIe), and many other applications.

Some of the key features to enable P2P networking include device discovery, authentication (provisioning) and group formation. To address these problems, the Wi-Fi Alliance (WFA) has established the “P2P Group” specification for P2P Group modes of operation on top of existing Wi-Fi specifications, e.g., 2.4 Gigahertz and 5 Gigahertz bands.

To enable device discovery, the WFA P2P specification relies on Probe Request/Response frames available in accordance with a given specification, e.g., the 802.11 specification. For example, STA A may broadcast a Probe Request frame to search for any other STA in its broadcasting range. If STA B receives the Probe Request from STA A, STA B may send back a unicast Probe Response frame addressed to STA A. Upon reception of the Probe Response, STA A may send back an Acknowledgment frame (ACK) to STA B to acknowledge the reception of the Probe Response frame.

Since STA A and STA B may be tuned to different social channels at different times, the WFA P2P specification, for example, defines that channels 1, 6, and 11 in the 2.4 Gigahertz band are used as social channels for P2P discovery. In other words, STAs attempting to perform P2P discovery will restrict the Probe Request and Probe Response procedure only to a few social channels, thereby decreasing the overall device discovery time.

However, when applied to communication bands of higher frequencies, for example, in the 60 Gigahertz band, the P2P discovery procedure in the WFA P2P specification becomes inefficient. Since communication at higher frequency bands, for example, in the 60 Gigahertz band, is directional and a STA may be capable of supporting N directions (e.g., up to 64 directions), the transmission of each Probe Request/Response frame must be performed up to N times. This procedure has a few drawbacks.

First, the effective data rate of each Probe Request/Response frame transmission may be greatly reduced, for example, to less than 1 Mbps, which is inefficient in terms of spectrum usage, may create unnecessary interference and may substantially increase the discovery time.

Second, the Probe Response frame requires that the receiving STA respond with an ACK frame shortly after receiving the Probe Response frame, e.g., after a pre-defined short interframe space (“SIFS”). There are two existing methods to deal with the ACK response.

According to one method, the ACK is transmitted only after the transmitter completes all N Probe Response frame transmissions. Apart from its inefficiency, this method creates a security threat as it allows a hacker significantly more time, which may be much longer than a typical SIFS, to create and transmit an ACK frame that may “impersonate” the receiving station.

According to another method, after transmitting each Probe Response, STA B awaits the SIFS period to receive an ACK from STA A. If STA B does not receive an ACK from STA A, then STA B transmits the Probe Response in another direction, and the procedure is repeated until STA B receives an ACK. This method may reduce the average number of transmissions required for discovery; however, due to SIFS overhead, both the average and the worst-case discovery time may be even longer than the discovery time of sequentially transmitting in all N directions.

Detecting nearby devices and initiating communication by sending probe signals in high frequency bands, for example, a 60 Gigahertz band, may include repeatedly transmitting probe requests by a STA to different directions (also known as “sweeping”) until detecting a second STA. In order to transmit as much information as possible, thus avoiding redundant additional transmissions, it might be preferable to transmit long probes. However, if a STA transmits long probes, e.g., probes that carry a large amount of data, the discovery time may be redundantly long.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIG. 2 is a schematic illustration of an exemplary beacon frame in accordance with some demonstrative embodiments.

FIG. 3 is a schematic flow-chart illustration of a method of establishing directional wireless communication in accordance with some demonstrative embodiments.

FIG. 4 is a schematic illustration of an article of manufacture in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a wired or wireless network, a wireless area network, a Wireless Video Area Network (WVAN), a Local Area Network (LAN), a Wireless LAN (WLAN), a Personal Area Network (PAN), a Wireless PAN (WPAN), devices and/or networks operating in accordance with existing IEEE 802.11 (IEEE 802.11-1999: Wireless LAN Medium Access Control (MAC) and Physical Layer (PHY) Specifications), 802.11a, 802.11b, 802.11g, 802.11h, 802.11j, 802.11n, 802.16, 802.16d, 802.16e, 802.16f, standards (“the IEEE 802 standards”) and/or future versions and/or derivatives thereof including 802.11 ad, devices and/or networks operating in accordance with existing Wireless-Gigabit-Alliance (WGA) and/or WirelessHD™ specifications and/or future versions and/or derivatives thereof, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), or the like. Other embodiments may be used in various other devices, systems and/or networks.

The term “wireless device” as used herein includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “sweeping” or “sweeping mode” as used herein, includes, for example, repeatedly transmitting signals in multiple directions from a wireless device, e.g., in order to discover or detect other wireless devices within communication range with the transmitting device. Sweeping may include, for example, transmitting communication signals in different directions and awaiting a response from communication devices within range of the transmission. “Omni-directional sweeping” may include, for example, transmitting signals sequentially in all directions of a given set of directions, e.g., to cover a substantially continuous area within a transmission range of the device and, after completing all transmissions, awaiting a response from one or more devices that may have received the signals. “Selective sweeping” may include transmitting signals sequentially in different directions and awaiting a response after each transmission. In this mode, if a response is not received within a predetermined time interval after each transmission, the transmitting device proceeds to transmit in another direction, and so on, until a response is received from one or more devices. Once a response is received, the selective sweeping process may end.

The term “beacon”, as used herein, may include any type of communication packet transmitted for the purpose of detection or notification of a device's whereabouts, e.g., for device discovery purposes. A beacon may be transmitted, for example, multiple times, and each transmitted beacon may include one or more frames. Each beacon frame may include information sufficient to initiate discovery of other communication devices.

The term “random” as used herein may include, for example, random, pseudo-random, unpredictable and/or haphazard. The term “random” as used herein may relate, for example, to one or more items or numbers that lack order, that appear to lack a pattern, that lack predictability, that appear to lack predictability, that lack a definitive pattern, that are haphazard or appear to be haphazard, that are generated or produced by a process whose output does not follow a describable pattern or a deterministic pattern, that do not follow a deterministic rule, that appear to not follow a deterministic rule, that appear to be chaotic or disorganized, or the like.

Some demonstrative embodiments may be used in conjunction with suitable limited-range or short-range wireless communication networks, for example, a wireless area network, a “piconet”, a WPAN, a WVAN, a wireless local area network and the like.

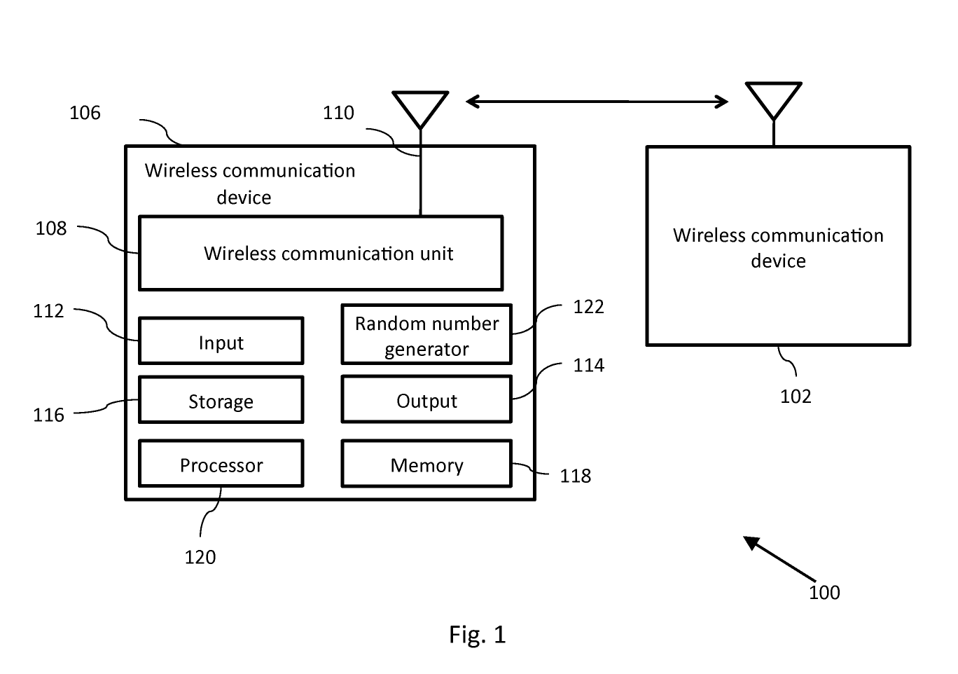

Reference is now made to FIG. 1, which schematically illustrates a block diagram of a system 100 in accordance with some demonstrative embodiments.

In some demonstrative embodiments, one or more devices of system 100 may be capable of communicating content, data, information and/or signals over one or more suitable wireless communication links, for example, a radio channel, an IR channel, a RF channel, a Wireless Fidelity (WiFi) channel, and the like. One or more devices of system 100 may optionally be capable of communicating over any suitable wired communication links.

As shown in FIG. 1, in some demonstrative embodiments, system 100 may include two or more devices, which communicate with each other wirelessly to transfer data.

In some demonstrative embodiments, system 100 may include wireless communication devices 106 and/or 102, either or both of which may include a wireless communication unit, for example, unit 108 of device 106, capable of receiving and/or transmitting wireless communication signals from/to one or more other devices of system 100, e.g., device 102.

In some demonstrative embodiments, wireless communication devices 106 and/or 102 may include, for example, a PC, a desktop computer, a mobile computer, a laptop computer, a notebook computer, a tablet computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a STB, a BD player, a BD recorder, a DVD player, a HD DVD player, a DVD recorder, a HD DVD recorder, a PVR, a broadcast HD receiver, a video source, an audio source, a video sink, an audio sink, a stereo tuner, a broadcast radio receiver, a flat panel display, a PMP, a DVC, a digital audio player, a speaker, an audio receiver, a gaming device, an audio amplifier, a data source, a data sink, a DSC, a media player, a Smartphone, a television, a music player, or the like.

In some demonstrative embodiments, devices 106 and/or 102 may include, for example, one or more processors 120, an input unit 112, an output unit 114, a memory unit 118, a storage unit 116, and a random number generator 122. Device 106 may optionally include other suitable hardware components and/or software components. In some demonstrative embodiments, some or all of the components of device 106 may be enclosed in a common housing or packaging, and may be interconnected or operably associated using one or more wired or wireless links. In other embodiments, components of device 106 may be distributed among multiple or separate devices or locations.

Processor 120 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 120 executes instructions, for example, of an Operating System (OS) of device 106, and/or of one or more suitable applications.

Input unit 112 includes, for example, a keyboard, a keypad, a mouse, a touch-pad, a track-ball, a stylus, a microphone, and/or any other suitable pointing device or input device. Output unit 114 includes, for example, a monitor, a screen, a flat panel display, a Cathode Ray Tube (CRT) display, a Liquid Crystal Display (LCD), an LED display, a plasma display unit, one or more audio speakers or earphones, or other suitable output devices.

Memory unit 118 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 116 includes, for example, a hard disk drive, a floppy disk drive, a Compact Disk (CD) drive, a CD-ROM drive, a DVD drive, or other suitable removable or non-removable storage units. Memory unit 118 and/or storage unit 116, for example, store data processed by device 106.

Random number generator 122 may include any computational or physical unit capable of generating a sequence of numbers or symbols that lack any pattern, i.e., appear random, to be used for randomizing periods of time between transmittal of communication packets.

In some demonstrative embodiments, wireless communication unit 108 includes or may be part of, for example, one or more wireless transmitters, receivers and/or transceivers able to send and/or receive wireless communication signals, RF signals, frames, blocks, transmission streams, packets, messages, specific data items, and/or any other type of communication data. For example, wireless communication unit 108 may include or may be implemented as part of any suitable wireless communication device, for example, a wireless Network Interface Card (NIC), and the like.

Wireless communication unit 108 may include, or may be associated with, one or more antennae 110. Antennae 110 may include, for example, an internal and/or external RF antenna, a dipole antenna, a monopole antenna, an omni-directional antenna, a switched beam antenna, a phased array antenna, an end fed antenna, a circularly polarized antenna, a micro-strip antenna, a diversity antenna, or other type of antenna suitable for transmitting and/or receiving wireless communication signals, blocks, frames, transmission streams, packets, messages and/or data.

In some demonstrative embodiments, device 106 may be capable of establishing a directional wireless communication link with one or more wireless communication devices, e.g., device 102, before transmitting probe requests of any size to the one or more wireless communication devices, e.g., as described in detail below.

In some demonstrative embodiments, wireless communication unit 108 of device 106 may be capable of transmitting and/or receiving discovery signals, e.g., beacons, to detect other wireless communication devices. According to some embodiments, wireless communication unit 108 may transmit one or more beacons in multiple directions in order to initiate communication with another wireless communication device, e.g., device 102, as described below.

In some demonstrative embodiments, wireless communication unit 108 may be capable of receiving beacons sent by other wireless communication devices, e.g., device 102, and may detect the other wireless communication device(s) according to the received beacon(s), also referred to herein as identification beacon(s), e.g., as explained below. In some embodiments, the beacons received by unit 108 from other communication devices, e.g., from device 102, are transmitted by the other device(s) in response to detection beacons sent from unit 108. In other embodiments, unit 108 may detect the other communication device(s) based on beacons that are transmitted independently by the other device(s). According to some embodiments, the beacons transmitted by device 102 may include sector sweep frames. In some embodiments, the sector sweep frames may be transmitted in a sweeping mode, e.g., as described above. The sector sweep frames may include information to enable other devices, e.g., device 106, to configure its antenna patterns for communicating directionally with device 102, as explained below.

In some demonstrative embodiments, after detecting device 102, e.g., by receipt or exchange of beacons, as described above and below, wireless communication unit 108 may proceed to configure a directional wireless transmission scheme for communicating with device 102, e.g., by configuring one or more of antennae 110 to transmit and/or receive signals efficiently in the direction of device 102. Device 106 may configure the one or more of antennae 110 by using a beam-forming technique, e.g., as explained below. For example, upon receiving the one or more beacons from device 102, wireless communication unit 108 may identify the direction of device 102 based on the information contained in the beacon received from device 102, and may respond to device 102, as described below.

In some demonstrative embodiments, device 106 and/or device 102 may configure their respective antennae using any beam-forming protocol known in the art, for example, by selecting a suitable sector for communication and/or by setting suitable phases to different antennae elements of a phased array antenna.

In some demonstrative embodiments, device 106 may operate in a sweeping mode, for example, device 106 may transmit a sector sweep frame that enables device 102 to identify the direction of device 106 and configure its antenna patterns for directional communication with device 106. According to some of these embodiments, after device 102 receives the sector sweep frame from device 106, both devices 102 and 106 may have sufficient information to determine their respective directions and configure a directional antenna pattern suitable for directional communication between devices 102 and 106.

In some demonstrative embodiments, after identifying the direction of device 102 based on antennae sector and/or direction information contained in the beacon, but prior to fully establishing a communication link between devices 106 and 102, wireless communication unit 108 may apply beam-forming techniques, e.g., as are known in the art, to configure a directional wireless transmission scheme suitable for communicating with device 102. Thereafter, the process of establishing a wireless communication link between devices 102 and 106 may proceed in a directional transmission mode. This is in contrast to prior art devices, wherein the entire process of establishing a wireless communication link between wireless devices is performed in a sweeping or omni-directional transmission mode, whereby a large amount of data may be transmitted many times, e.g., by transmitting a series of lengthy probe requests in different directions, until a communication link is obtained.

In some demonstrative embodiments, once a directional transmission scheme is configured, wireless communication unit 108 may establish a wireless communication link between devices 106 and 102 using the directional wireless transmission scheme, e.g., as described in detail below. For example, according to some demonstrative embodiments, after unit 108 configures a suitable directional transmission scheme for communicating with device 102, unit 108 may proceed to transmit a probe request directionally to device 102, using the directional wireless transmission scheme, and/or device 102 may transmit a probe response or other identifying signal to device 106. Except for the use of a directional wireless transmission scheme, the establishment of a wireless communication link, e.g., using probe requests and probe responses, may be performed according to protocols as are known in the art.

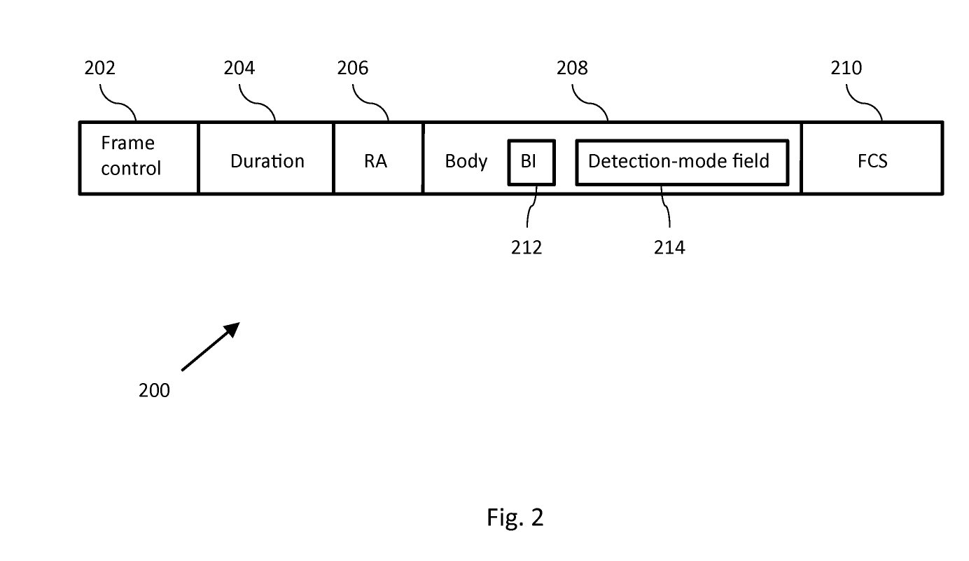

Reference is now made to FIG. 2, which schematically illustrates an exemplary beacon frame, in accordance with some demonstrative embodiments.

In some demonstrative embodiments, beacon frame 200 includes a frame control field 202, a duration field 204, a receiver address (RA) field 206, a body section 208, and a frame check sequence (FCS) field 210. Beacon frame 200 may be or may include a frame of a mmWave beacon transmitted over a 60 Gigahertz frequency band, or any other high frequency range that requires directional communication.

According to some demonstrative embodiments, a beacon transmitted by wireless communication device 106 may include one or more beacon frames, e.g., beacon frame 200. According to some embodiments, transmitting a beacon may refer to simultaneous or sequential transmission of two or more beacon frames in different directions.

According to some demonstrative embodiments, the sequence of beacon frames may be transmitted in a sweeping mode, i.e., beacon frame 200 and/or similar beacon frames may be transmitted repeatedly in different directions.

In some demonstrative embodiments, body section 208 includes a beacon interval (BI) field 212 and a detection-mode field 214.

In some demonstrative embodiments, beacon frame 200 may be transmitted as part of a plurality of beacon frames, which may be referred to herein collectively or separately as “beacon(s)”. The value of beacon interval (BI) field 212 of each beacon frame included in the beacon may indicate a time interval between the transmission of the current beacon and a successive beacon in a sequence of beacons. For example, BI field 212 with a value of 2 milliseconds (ms) indicates that a next consecutive beacon will be transmitted by device 106 (FIG. 1), 2 ms after the transmission of the current beacon, which may include one or more beacon frames identical or similar to beacon frame 200.

In some demonstrative embodiments, detection-mode field 214 may have a first predefined value indicating that beacon frame 200 is transmitted from a wireless communication device attempting to detect other wireless communication devices, or a second predefined value, which may indicate that beacon frame 200 is transmitted by a network controller of a wireless communication network, as explained below.

Referring back to FIG. 1, in accordance with some embodiments, wireless communication unit 108 of device 106 may be capable of transmitting a multi-directional sequence of detection beacons in a sweeping mode, i.e., multiple beacons that are transmitted sequentially in multiple directions, and detecting at least one other wireless communication device, for example, device 102, based on at least one of the following procedures.

After transmitting one or more detection beacons, device 106 may receive a response beacon identifying one or more wireless communication devices, e.g., wireless communication device 102. For example, after transmitting a beacon including beacon frame 200 (FIG. 2), device 106 may detect device 102 based on a response beacon received from device 102. The response beacon may contain information that enables devices 102 and 106 to configure their respective antennae according to a directional transmission scheme, e.g., using beam-forming techniques, and then to use the directional transmission to scheme establish a directional communication link between the devices.

According to some embodiments, the response beacon may include one or more sector sweep frames, e.g., as explained above.

Additionally or alternatively, in some embodiments, device 106 may detect other wireless communication devices based on one or more beacons transmitted independently by the other devices, i.e., not in response to the detection beacon(s) sent by unit 108. For example, device 106 may detect device 102 based on a beacon sent autonomously by device 102, i.e., not in response to the beacon sent by device 106.

According to some embodiments, it is not desirable to allow two or more wireless communication devices, for example, devices 106 and 102, to transmit beacons with the same BI values simultaneously. For example, if device 106 transmits a beacon including one or more beacon frames with a BI value of 3 ms, and device 102 simultaneously also transmits a beacon including one or more beacon frames with a BI value of 3 ms, then the two devices might be unable to receive their respectively transmitted beacons and may thus be unable to detect each other and communicate. According to some demonstrative embodiments, conflicts in transmission of beacons by different devices may be prevented by randomization of the BI value as described below.

As explained above, a beacon may include multiple beacon frames, such as beacon frame 200 (FIG. 2), which may be identical or similar to each other. According to some embodiments, a sequence of beacons may be transmitted, wherein each transmitted beacon in the sequence has a beacon interval (BI) value, which may be included in BI field 212 (FIG. 2). The BI value indicates a time interval between a currently transmitted beacon and a successive beacon to be transmitted in the sequence.

To avoid simultaneous transmission of beacons by more than one device, according to some demonstrative embodiments, two or more of the beacons in the sequence of beacons transmitted by device 106 may have two or more different BI values, respectively. For example, device 106 may transmit a detection beacon, e.g., beacon frame 200 (FIG. 2) with a BI value of 3 ms, and may subsequently transmit another beacon with a BI value of 5 ms.

In some demonstrative embodiments, random number generator 122 of device 106 may generate random BI values in BI field 212 (FIG. 2) of each beacon transmitted by device 106. It will be appreciated that transmitting a sequence of beacons, with randomly-generated BI values in field 212 (FIG. 2) significantly increases the probability that device 102 will be available to receive the beacons transmitted by device 106, and vice versa.

In some demonstrative embodiments, detection-mode field 214 (FIG. 2) may have a first predefined value, e.g., “1”, indicating that device 106 is a client station in detection mode and/or that beacon frame 200 (FIG. 2) is a detection beacon for detecting other wireless communication devices. Alternatively, detection-mode field 214 may have a second predefined value, e.g., “0”, indicating that beacon frame 200 (FIG. 2) is transmitted by a network controller of a wireless communication network, for example, an Access Point (AP), a Primary/PBSS Control Point (PCP) or a Base Station (BS) in a wireless communication network, such as, for example, IEEE 802.11 basic service set (BSS), IEEE 802.15.3 or IEEE 802.16.

In some demonstrative embodiments, pursuant to the exchange of detection beacons, and after a directional wireless transmission scheme has been configured for communicating with a particular detected device, e.g., device 102, wireless communication unit 108 may proceed to establish a wireless communication link with the detected device, by exchanging signals directionally with the detected device, e.g., device 102.

In some demonstrative embodiments, device 106 may initiate the establishment of the wireless communication link with device 102 by directionally transmitting a probe request to device 102. In some embodiments, each probe request and each probe response may include multiple frames. The probe request frame transmitted by device 106 may include information regarding services provided by device 106, e.g., printing services, display services, etc. According to some embodiments, if device 102 is intended to use the services provided by device 106 or is intended to offer services to device 106, then device 102 may respond to the probe request by transmitting a probe response directionally to device 106. According to some embodiments, after receiving the probe response, device 106 may directionally transmit an ACK frame to device 102, to confirm receipt of the probe response and/or to establish the wireless communication link between devices 102 and 106. This is in contrast to prior art systems, wherein signals carrying probe requests, probe responses and/or ACK frames, which may include large amounts of data, are transmitted or exchanged multiple times, e.g., in an omni-directional mode or a sweeping mode, i.e., not directionally, until a wireless communication link is established between the wireless devices.

In some demonstrative embodiments, the wireless communication link established between devices 106 and 102 may represent any type of end-to-end communication link between two systems or devices, e.g., a point-to-point communication link.

In some demonstrative embodiments, the wireless communication link established between devices 106 and 102 may include transmissions in a 60 Gigahertz frequency band or other high frequency band that requires directional communication.

In some demonstrative embodiments, a predefined social channel may be assigned to the exchange of beacons between devices 106 and 102, and/or other devices, and the same social channel may then be used to complete the process of establishing a wireless communication link between devices 106 and 102, e.g., by exchanging probe requests, probe responses and/or ACK signals. For example, channel 2 in the 60 Gigahertz frequency band may be defined as a default channel for transmission of beacon signals, as well as for the exchange of probe requests, probe responses and/or ACK signals. Alternatively, multiple channels (e.g., any or all channels) in the 60 Gigahertz band or other high frequency band may be used as social channels as well as for device discovery.

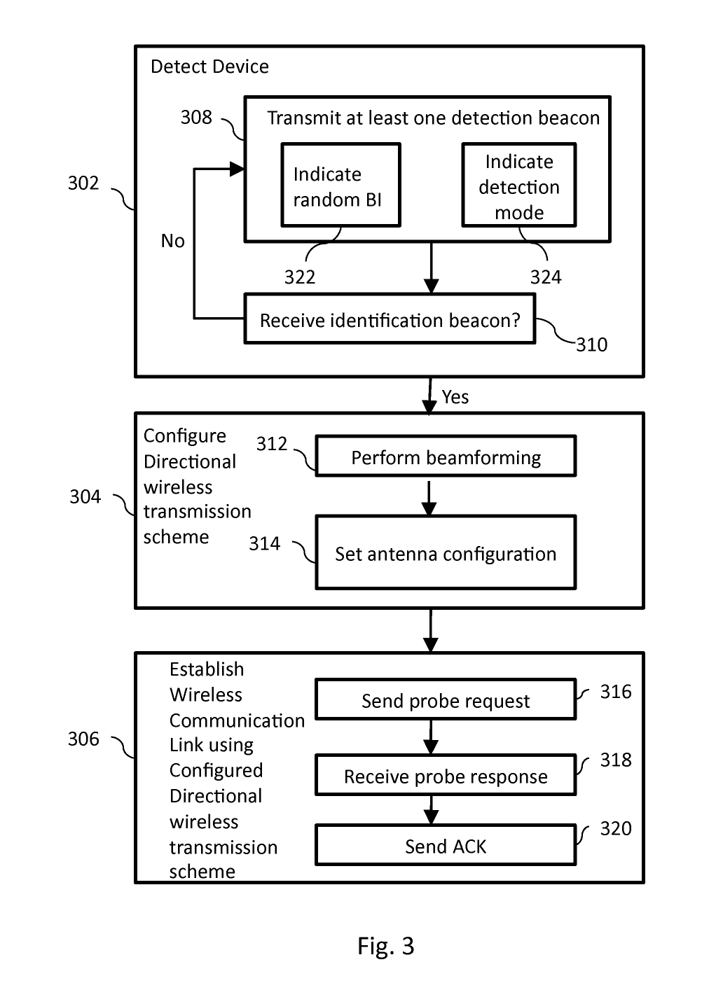

Reference is now made to FIG. 3, which schematically illustrates a method of establishing directional wireless communication, in accordance with some demonstrative embodiments. In some demonstrative embodiments, one or more of the operations of the method of FIG. 3 may be performed by a wireless communication unit, for example, wireless communication unit 108 of device 106 (FIG. 1) and/or any other wireless communication device capable of sending and receiving wireless communication signals.

As indicated at block 302, the method may include detecting a device. For example, wireless communication unit 108 (FIG. 1) of wireless communication device 106 (FIG. 1) may detect wireless communication device 102 (FIG. 1), e.g., as described above and below.

As indicated at block 308, the method may include transmitting at least one detection beacon to attempt detection of another wireless communication device, e.g., device 102 (FIG. 1).

As indicated at block 322, transmitting the at least one detection beacon as indicated in block 308 may include transmitting a detection beacon having a random beacon interval value, for example, a detection beacon having a randomized BI value in BI field 212 (FIG. 2).

As indicated at block 324, transmitting the at least one detection beacon as indicated in block 308 may include transmitting a detection beacon having a detection mode value, e.g., in detection field 214 (FIG. 2), to indicate that the transmitted beacon, e.g., beacon frame 200, is a detection beacon.

As indicated at block 310, the method may include receiving an identification beacon from another wireless communication device, e.g., device 102 (FIG. 1). If no identification beacon is received in response to the detection beacon, the method may include transmitting another detection beacon as indicated in block 308, and so on, until an identification beacon is received. Although block 302 indicates that the identification beacon is received in response to the detection beacon, in some embodiments the received identification beacon may be independently transmitted by the other wireless communication device, e.g., device 102 (FIG. 1), and not in response to a detection beacon. According to these embodiments, the other wireless communication device, e.g., device 102 (FIG. 1), is detected based on its independently-transmitted identification beacon, which may include frames with sufficient information to determine transmission directionality, for example, frames similar to detection frame 200 (FIG. 2).

As indicated at block 304, the method may include configuring a directional wireless transmission scheme for communicating with the detected device.

As indicated at block 312, configuring the directional wireless transmission scheme may include applying beam-forming techniques, as described above and/or as is know in the art.

As indicated at block 314, configuring the directional wireless transmission scheme may include configuring the one or more antennae of device 106 (FIG. 1), e.g., antennae 110, to enable efficient communication in the direction of wireless communication device 102 (FIG. 1), as explained above.

As indicated at block 306, the method may include establishing a wireless communication link with the detected device using the configured directional wireless transmission scheme.

As indicated at block 316, establishing the wireless communication link may include directionally transmitting a probe request to the detected device. For example, device 106 (FIG. 1) may send a probe request in the direction of device 102 (FIG. 1) using the directional wireless transmission scheme described above.

As indicated at block 318, establishing the wireless communication link may include receiving a probe response from the detected wireless communication device, e.g., device 102. Since at this point device 102 and device 106 are already in direct communication, after performing beam-forming of their respective antennae, e.g., based on the exchange of beacon described above, device 102 may be able to directionally transmit the probe response to device 106.

As indicated at block 316, to complete the process of establishing a wireless communication link between devices 106 and 102 after the directional exchange of probe request and probe response, device 106 may transmit an ACK frame directionally to device 102. The ACK frame may be transmitted after a predefined SIFS interval.

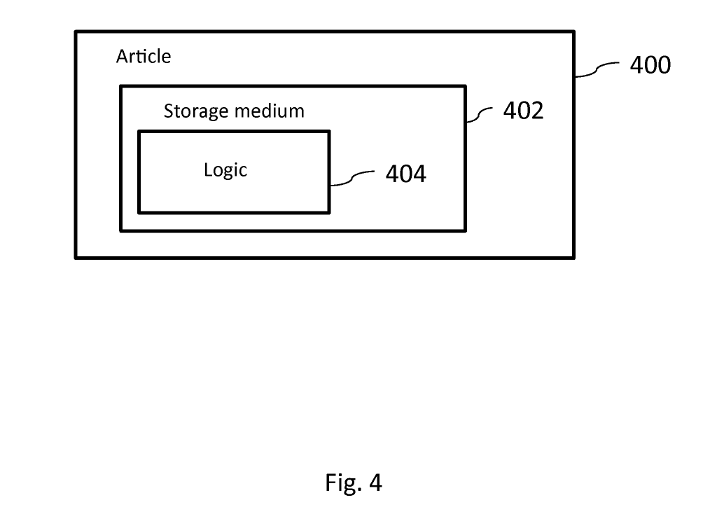

Reference is made to FIG. 4, which schematically illustrates an article of manufacture 400, in accordance with some demonstrative embodiments. Article 400 may include a machine-readable storage medium 402 to store logic 404, which may be used, for example, to perform at least part of the functionality of wireless communication unit 108 (FIG. 1) and/or wireless communication device 106 (FIG. 1); and/or to perform one or more operations of the method of FIG. 3.

In some demonstrative embodiments, article 400 and/or machine-readable storage medium 402 may include one or more types of computer-readable storage media capable of storing data, including volatile memory, non-volatile memory, removable or non-removable memory, erasable or non-erasable memory, writeable or re-writeable memory, and the like. For example, machine-readable storage medium 402 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 404 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 404 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A wireless communication device comprising:
a wireless communication unit to detect another wireless communication device based on one or more beacons, to configure a directional wireless transmission scheme for communicating with the other wireless communication device based on the one or more beacons, and to establish a wireless communication link with the other wireless communication device using the directional wireless transmission scheme.

2. The device of claim 1, wherein the one or more beacons comprise at least one beacon received from the other wireless communication device.

3. The device of claim 1, wherein the wireless communication unit is to transmit at least one detection beacon, to receive at least one response beacon from the other wireless communication device, and to detect the other wireless communication device based on the at least one response beacon.

4. The device of claim 3, wherein the at least one detection beacon includes a detection-mode field having a value indicating that the at least one detection beacon is intended to detect the other wireless communication device.

5. The device of claim 3, wherein the at least one detection beacon comprises a sequence of detection beacons, and wherein two or more of the detection beacons in the sequence of detection beacons have two or more different Beacon Interval (BI) values, respectively.

6. The device of claim 5, wherein the wireless communication device comprises a Random Number Generator to generate random values for the two or more different BI values.

7. The device of claim 1, wherein the wireless communication unit is to configure the directional wireless transmission scheme by configuring one or more antennae of the wireless communication device to transmit directionally in the direction of the other wireless communication device.

8. The device of claim 7, wherein the wireless communication unit is to configure the one or more antennae of the wireless communication device by a beam-forming technique.

9. The device of claim 1, wherein the wireless communication unit is to establish the wireless communication link by directionally exchanging one or more probe requests and one or more probe responses with the other wireless communication device using the directional wireless transmission scheme.

10. The device of claim 1, wherein the wireless communication link includes a point-to-point communication link.

11. The device of claim 1, wherein the wireless communication link includes a wireless communication link in a 60 Gigahertz or higher frequency band.

12. A method comprising:
detecting a wireless communication device based on one or more beacons;
configuring a directional wireless transmission scheme directed to communicate with the wireless communication device; and
establishing a directional wireless communication link with the wireless communication device using the directional wireless transmission scheme.

13. The method of claim 12, wherein detecting the wireless communication device comprises receiving at least one beacon from the wireless communication device.

14. The method of claim 12, wherein detecting the wireless communication device comprises transmitting at least one detection beacon, receiving at least one response beacon from the wireless communication device, and detecting the wireless communication device based on the at least one response beacon.

15. The method of claim 14, wherein transmitting the at least one beacon comprises transmitting a sequence of beacons, and wherein two or more of the beacons in the sequence of beacons have two or more different Beacon Interval (BI) values, respectively.

16. The method of claim 15, comprising generating random values for the two or more different Beacon Interval (BI) values.

17. The method of claim 12, wherein configuring the directional wireless transmission scheme comprises configuring one or more antennae to transmit directionally in the direction of the wireless communication device.

18. The method of claim 17, wherein configuring the one or more antennae comprises applying a beam-forming technique.

19. The method of claim 12, wherein establishing a directional wireless communication link comprises directionally exchanging one or more probe requests and one or more probe responses with the wireless communication device using the directional wireless transmission scheme.

20. A system comprising:
at least one wireless communication device including:
one or more antennae to transmit and receive signals; and
a wireless communication unit to detect another wireless communication device,
to configure a directional wireless transmission scheme of the one or more antenna directed to communicate with the other wireless communication device, and to establish a wireless communication link with the other wireless communication device using the directional wireless transmission scheme.

21. The system of claim 20, wherein the wireless communication unit is to detect the other wireless communication device based on one or more beacons received from the other wireless communication device.

22. The system of claim 20, wherein the wireless communication unit is to transmit at least one detection beacon, to receive at least one response beacon from the other wireless communication device, and to detect the other wireless communication device based on the at least one response beacon.

23. The system of claim 20, wherein the wireless communication unit is to configure the directional wireless transmission scheme based on at least one beacon received from the other wireless communication device.

24. The system of claim 20, wherein the wireless communication unit is to configure the directional wireless transmission scheme by configuring one or more antennae of the wireless communication device to transmit directionally in the direction of the other wireless communication device.

25. A product including a storage medium having stored thereon instructions that, when executed by a machine, result in:
detecting a wireless communication device based on one or more beacons;
configuring a directional wireless transmission scheme directed to communicate with the wireless communication device; and
establishing a directional wireless communication link with the wireless communication device using the directional wireless transmission scheme.

26. The product of claim 25, wherein the instructions that result in detecting the wireless communication device result in receiving at least one beacon from the wireless communication device.

27. The product of claim 25, wherein the instructions that result in detecting the wireless communication device result in transmitting at least one detection beacon, receiving at least one response beacon from the wireless communication device, and detecting the wireless communication device based on the at least one response beacon.

28. The product of claim 25, wherein the instructions that result in configuring the directional wireless transmission scheme result in configuring one or more antennae to transmit directionally in the direction of the wireless communication device.

29. The product of claim 25, wherein the instructions that result in establishing a directional wireless communication link result in directionally exchanging one or more probe requests and one or more probe responses with the wireless communication device using the directional wireless transmission scheme.
